(19) United States
(12) Patent Application Publication
(10) Pub. No.: US 2016/0370953 A1
(43) Pub. Date: Dec. 22, 2016

(54) Managing the Presentation of Elements Via a User Interface of a Computing Device.

(71) Applicant: International Business Machines Corporation, Armonk, NY (US)

(72) Inventors: Aharon Abadi, Petach Tikva (IL); Samuel Kallner, D.N.Menashe (IL); Andrei Kirshin, Haifa (IL); Yoav Rubin, Haifa (IL)

(21) Appl. No.: 14/741,468

(22) Filed: Jun. 17, 2015

(51) Int. Cl. G06F 3/0482

(52) U.S. Cl. CPC G06F 3/0482

(57) ABSTRACT

Managing the presentation of elements via a user interface of a computing device, by selecting a candidate element from a plurality of candidate elements for presentation via a user interface of a computing device, where each of the candidate elements is associated with a level of detail in a hierarchy of multiple levels of detail, where the level of detail of the selected candidate element is at or above a current presentation level of detail in the hierarchy of multiple levels of detail, and where the current presentation level of detail is applicable to a current presentation context of a software application that is executed by the computing device, and presenting the selected candidate element in the current presentation context of the software application via the user interface of the computing device.

### BACKGROUND

One of the challenges in developing modern software applications is adapting software applications to the small screen size of mobile computing devices. Too often, user interfaces of software applications appear crowded on small screens, and users are overloaded with too much information in too small a visual field, rendering such software applications inefficient. Moreover, different data elements are often of varying importance to the user, requiring the small screen user to spend time scrolling the screen to locate important data.

### SUMMARY

In one aspect of the invention a method is provided for managing the presentation of elements via a user interface of a computing device, the method including selecting a candidate element from a plurality of candidate elements for presentation via a user interface of a computing device, where each of the candidate elements is associated with a level of detail in a hierarchy of multiple levels of detail, where the level of detail of the selected candidate element is at or above a current presentation level of detail in the hierarchy of multiple levels of detail, and where the current presentation level of detail is applicable to a current presentation context of a software application that is executed by the computing device, and presenting the selected candidate element in the current presentation context of the software application via the user interface of the computing device.

In other aspects of the invention systems and computer program products embodying the invention are provided.

### BRIEF DESCRIPTION OF THE DRAWINGS

Aspects of the invention will be understood and appreciated more fully from the following detailed description taken in conjunction with the appended drawings in which:

FIG. 1 is a simplified conceptual illustration of a system for managing the presentation of elements via a user interface of a computing device, constructed and operative in accordance with an embodiment of the invention;

FIGS. 2A-2C are exemplary application screen useful in illustrating the operation of the system of FIG. 1;

FIG. 3 is a simplified flowchart illustration of an exemplary method of operation of the system of FIG. 1, operative in accordance with an embodiment of the invention; and

FIG. 4 is a simplified block diagram illustration of an exemplary hardware implementation of a computing system, constructed and operative in accordance with an embodiment of the invention.

### DETAILED DESCRIPTION

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

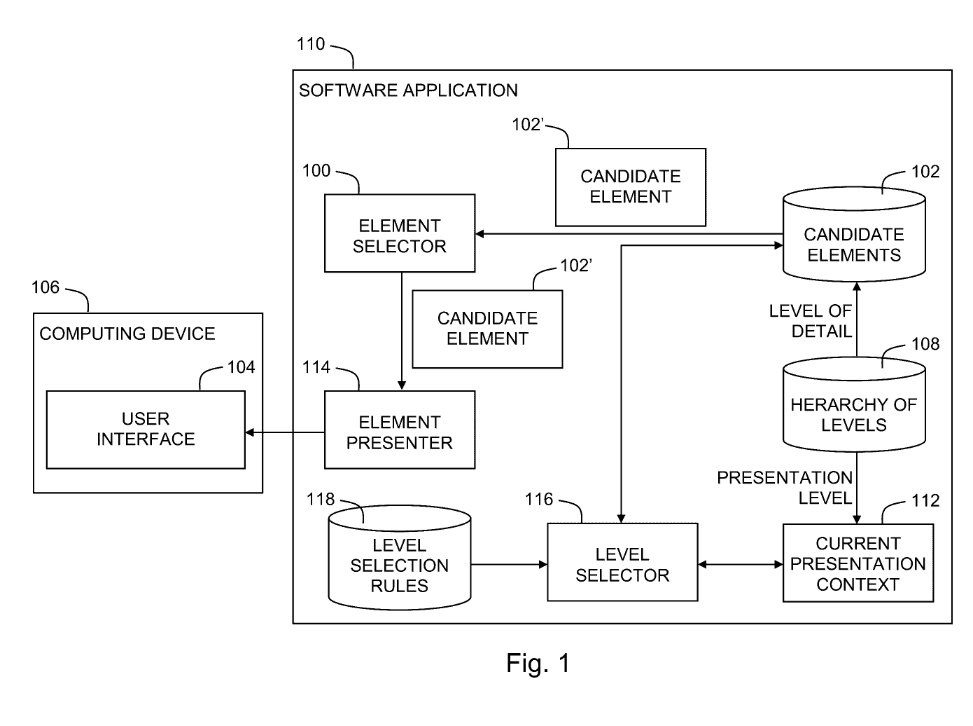

Reference is now made to FIG. 1, which is a simplified conceptual illustration of a system for managing the presentation of elements via a user interface of a computing device, constructed and operative in accordance with an embodiment of the invention. In the system of FIG. 1 an element selector 100 is configured to select a candidate element 102′, such as a data element or a user interface element, from among a group of candidate elements 102 for presentation via a user interface 104, such as a display or a speaker, of a computing device 106. Each of the candidate elements in group 102 is associated with a level of detail in a hierarchy of multiple levels of detail 108. Element selector 100 selects candidate element 102′ if its level of detail is at or above a current presentation level of detail in the hierarchy of multiple levels of detail, where the current presentation level of detail is associated with a current presentation context 112, such as on a particular screen or screen portion, of a software application 110 that is executed by computing device 106. An element presenter 114 is configured to present selected candidate element 102′ in the current presentation context of software application 110 via user interface 104 of computing device 106.

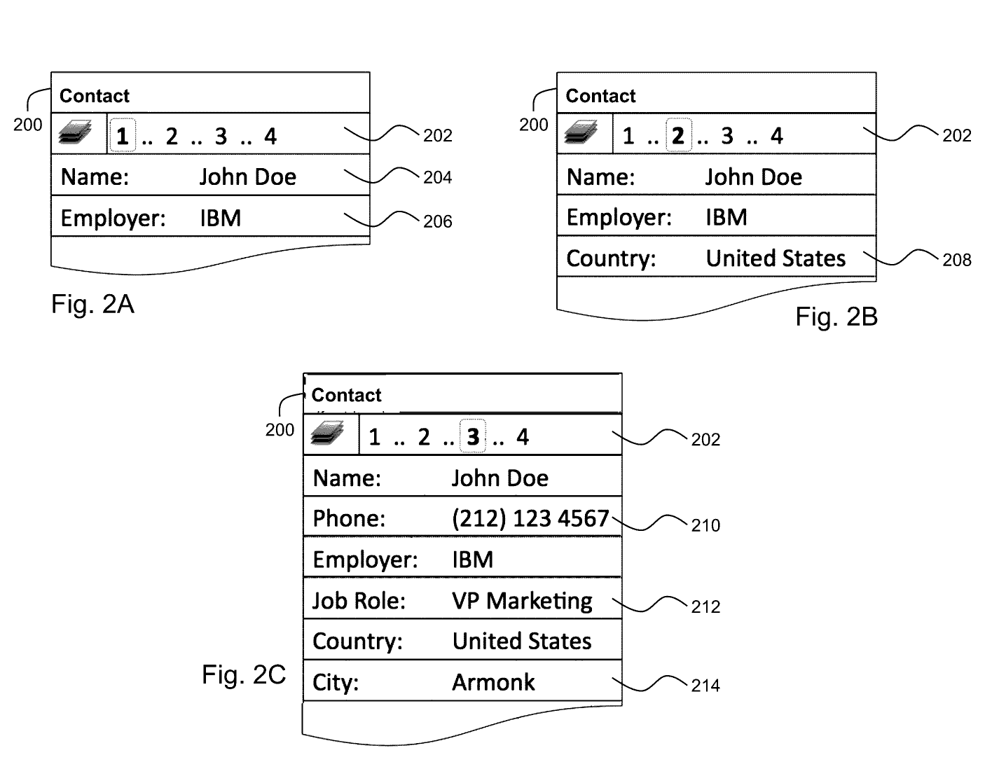

The operation of the system of FIG. 1 may be illustrated with additional reference to the examples shown in FIGS. 2A-2C in which a screen 200 of a customer contact information application is shown for three different current presentation levels as indicated by a presentation level indicator 202. Screen 200 includes the following candidate data elements and their associated levels of detail in a hierarchy of multiple levels of detail, where ‘1’ is the highest level, followed by increasingly lower levels ‘2,’ ‘3,’ and ‘4.’:

| Data Element | Associated Level of Detail |
|---|---|
| “Name” 204 | 1 |
| “Employer” 206 | 1 |
| “Country” 208 | 2 |
| “Phone” 210 | 3 |
| “Job Role” 212 | 3 |
| “City” 214 | 3 |

In FIG. 2A, presentation level indicator 202 indicates that the current presentation level of detail of screen 200 is ‘1,’ and thus “Name” 204 and “Employer” 206 are selected for presentation, as their associated level of detail is also ‘1.’ In FIG. 2B, presentation level indicator 202 indicates that the current presentation level of detail of screen 200 is ‘2,’ and thus “Name” 204 and “Employer” 206 are selected for presentation, as their associated level of detail of ‘1’ is at or above the current presentation level of detail of ‘2,’ and “Country” is also selected for presentation, as its associated level of detail is ‘2.’ In FIG. 2C, presentation level indicator 202 indicates that the current presentation level of detail of screen 200 is ‘2,’ and thus “Name” 204 and “Employer” 206 are selected for presentation, as their associated level of detail of ‘1’ is at or above the current presentation level of detail of ‘3,’ “Country” is also selected for presentation, as its associated level of detail of ‘2’ is at or above the current presentation level of detail of ‘3,’ and “Phone” 210, “Job Role” 212, and “City” 214 are also selected for presentation, as their associated level of detail is ‘3.’

It is appreciated that a presentation level of detail may be associated with a software application at an application-wide level, or in any of a variety of presentation contexts, such as at an application screen level, where different presentation levels of detail are associated with various screens of the software application, and/or where different portions of a screen have different presentation levels of detail.

The system of FIG. 1 may also include a level selector 116 configured to set a presentation level of detail associated with software application 110, such as based on the display size of the computing device 106 in accordance with predefined rules that associate different presentation levels with different display sizes, or equal to a user-indicated presentation level of detail that may be provided by a user of software application 110 using conventional techniques. Level selector 116 may additionally or alternatively be configured to set the level of detail of any of candidate elements 102, such as equal to a user-indicated level of detail. Level selector 116 may additionally or alternatively be configured to set the level of detail of any of candidate elements 102 based on one or more characteristics of candidate elements 102 and in accordance with one or more predefined level selection rules 118, at the time software application 110 is designed and/or when software application 110 is executed. Some non-limiting examples of such predefined level selection rules 118 and their application to characteristics of candidate elements 102 may include:
an element that includes a navigational component, such as a button or a hyperlink, may be associated with a higher level of detail than an element that lacks a navigational component;
an element that is referenced only once within the application may be associated with the lowest level of detail;
an element may be associated with a level of detail based on whether the element appears higher up or lower down in an application screen;
an element whose name is identical to, similar to, or synonymous with a term in a predefined set of important terms in a given domain may be associated with a higher level of detail than an element whose name is not;
an element whose name is identical to, similar to, or synonymous with the names of elements that appear elsewhere within the application may be associated with a higher level of detail than an element whose name is not;
an element whose name is identical to, similar to, or synonymous with a screen or section heading may be associated with a higher level of detail than an element whose name is not;
an element that is user-editable may be associated with a higher level of detail than an element that is not.

Element selector 100, element presenter 114, and level selector 116 may be incorporated into software application 110 or may operate separately therefrom.

Any of the elements shown in FIG. 1 are preferably implemented in computer hardware and/or in computer software embodied in a non-transitory, computer-readable medium in accordance with conventional techniques.

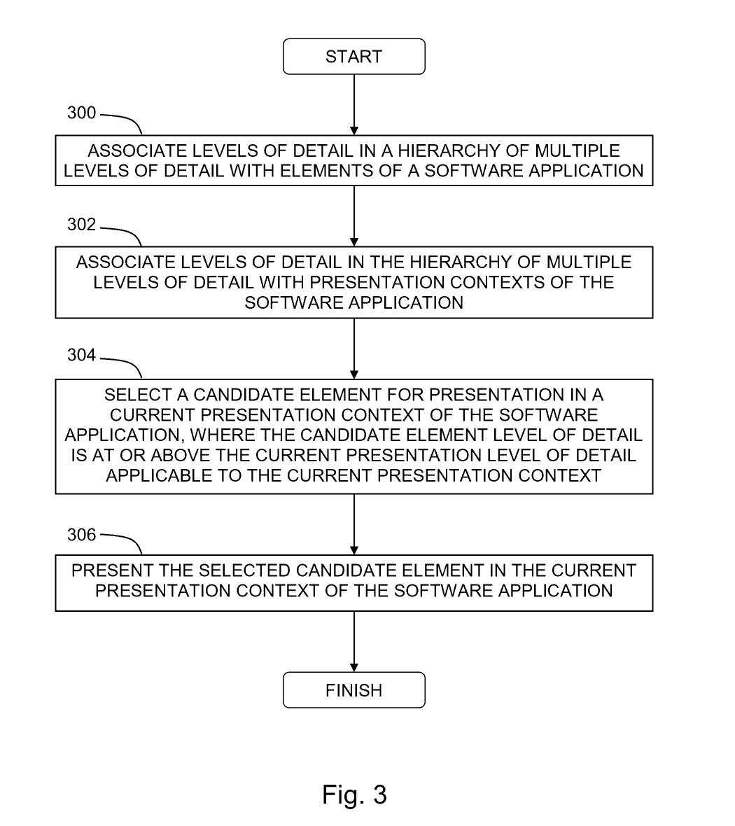

Reference is now made to FIG. 3 which is a simplified flowchart illustration of an exemplary method of operation of the system of FIG. 1, operative in accordance with an embodiment of the invention. In the method of FIG. 3, a user-input or rule-derived level of detail in a hierarchy of multiple levels of detail is associated with elements of a software application, such as data elements or a user interface elements, that are candidates for presentation via a user interface of a computing device (step 300). A user-input or rule-derived presentation level of detail is associated with the software application and/or with any presentation contexts of the software application, such as with any of its screens or portions thereof (step 302). Given a current presentation context of the software application and a current presentation level of detail applicable to the current presentation context, such as a presentation level of detail associated with the current presentation context or a default presentation level of detail associated with the software application if the current presentation context does not have an associated presentation level of detail, a candidate element is selected for presentation in the current presentation context via a user interface of the computing device if the level of detail of the selected candidate element is at or above the current presentation level of detail applicable to the current presentation context (step 304). The selected candidate element is presented in the current presentation context of the software application via a user interface of the computing device (step 306).

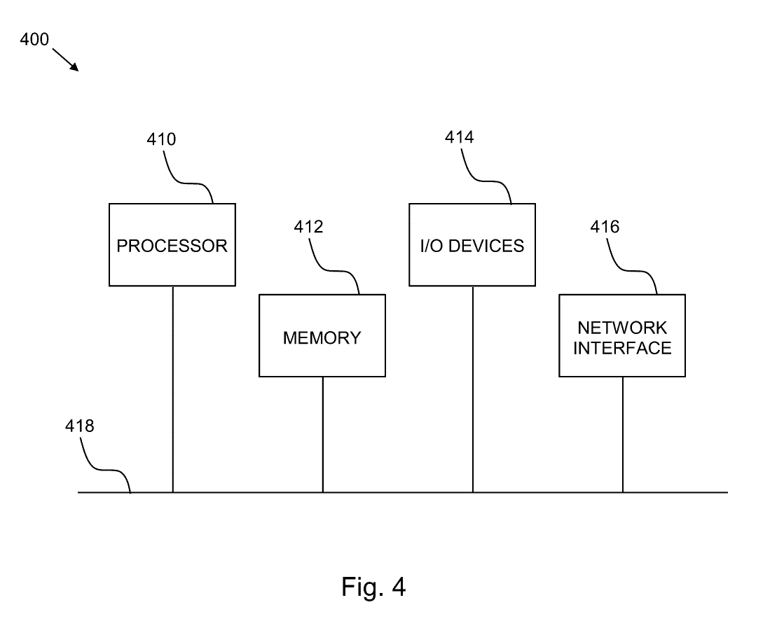

Referring now to FIG. 4, block diagram 400 illustrates an exemplary hardware implementation of a computing system in accordance with which one or more components/methodologies of the invention (e.g., components/methodologies described in the context of FIGS. 1-3) may be implemented, according to an embodiment of the invention.

As shown, the techniques for controlling access to at least one resource may be implemented in accordance with a processor 410, a memory 412, I/O devices 414, and a network interface 416, coupled via a computer bus 418 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for managing the presentation of elements via a user interface of a computing device, the method comprising:
selecting a candidate element from a plurality of candidate elements for presentation via a user interface of a computing device,
wherein each of the candidate elements is associated with a level of detail in a hierarchy of multiple levels of detail,
wherein the level of detail of the selected candidate element is at or above a current presentation level of detail in the hierarchy of multiple levels of detail, and
wherein the current presentation level of detail is applicable to a current presentation context of a software application that is executed by the computing device; and
presenting the selected candidate element in the current presentation context of the software application via the user interface of the computing device.

2. The method according to claim 1 wherein the selecting comprises selecting wherein the current presentation level of detail is associated with at least a portion of a screen of the software application.

3. The method according to claim 1 and further comprising setting the current presentation level of detail equal to a user-indicated level of detail.

4. The method according to claim 1 and further comprising setting the level of detail of any of the candidate elements equal to a user-indicated level of detail.

5. The method according to claim 1 and further comprising setting the level of detail of any of the candidate elements based on a characteristic of the candidate element and in accordance with a predefined rule.

6. The method according to claim 1 and further comprising setting the current presentation level of detail based on a display size of the computing device.

7. The method according to claim 1 wherein the presenting comprises presenting wherein the selected candidate element is any of a data element and a user interface element.

8. The method according to claim 1 wherein the presenting comprises presenting wherein the user interface is a display.

9. The method of claim 1 wherein the selecting and presenting are implemented in any of
a) computer hardware, and
b) computer software embodied in a non-transitory, computer-readable medium.

10. A system for managing the presentation of elements via a user interface of a computing device, the system comprising:
an element selector configured to select a candidate element from a plurality of candidate elements for presentation via a user interface of a computing device,
wherein each of the candidate elements is associated with a level of detail in a hierarchy of multiple levels of detail,
wherein the level of detail of the selected candidate element is at or above a current presentation level of detail in the hierarchy of multiple levels of detail, and
wherein the current presentation level of detail is applicable to a current presentation context of a software application that is executed by the computing device; and
an element presenter configured to present the selected candidate element in the current presentation context of the software application via the user interface of the computing device.

11. The system according to claim 10 wherein the current presentation level of detail is associated with at least a portion of a screen of the software application.

12. The system according to claim 10 and further comprising a level selector configured to set the current presentation level of detail equal to a user-indicated level of detail.

13. The system according to claim 10 and further comprising a level selector configured to set the level of detail of any of the candidate elements equal to a user-indicated level of detail.

14. The system according to claim 10 and further comprising a level selector configured to set the level of detail of any of the candidate elements based on a characteristic of the candidate element and in accordance with a predefined rule.

15. The system according to claim 10 and further comprising a level selector configured to set the current presentation level of detail based on a display size of the computing device.

16. The system according to claim 10 wherein the selected candidate element is any of a data element and a user interface element.

17. The system according to claim 10 wherein the user interface is a display.

18. The system of claim 10 wherein the element selector and the element presenter are implemented in any of
a) computer hardware, and
b) computer software embodied in a non-transitory, computer-readable medium.

19. A computer program product for managing the presentation of elements via a user interface of a computing device, the computer program product comprising:
a non-transitory, computer-readable storage medium; and
computer-readable program code embodied in the storage medium, wherein the computer-readable program code is configured to
select a candidate element from a plurality of candidate elements for presentation via a user interface of a computing device,
wherein each of the candidate elements is associated with a level of detail in a hierarchy of multiple levels of detail,
wherein the level of detail of the selected candidate element is at or above a current presentation level of detail in the hierarchy of multiple levels of detail, and
wherein the current presentation level of detail is applicable to a current presentation context of a software application that is executed by the computing device, and
present the selected candidate element in the current presentation context of the software application via the user interface of the computing device.

20. The computer program product according to claim 19 wherein the computer-readable program code is configured to set the level of detail of any of the candidate elements based on a characteristic of the candidate element and in accordance with a predefined rule.
